(19) United States
(12) Patent Application Publication
(10) Pub. No.: US 2022/0312304 A1
(43) Pub. Date: Sep. 29, 2022

(54) METHOD AND APPARATUS FOR COLLECTING DATA THROUGH EVENT EXPOSURE SERVICE

(71) Applicant: ELECTRONICS AND TELECOMMUNICATIONS RESEARCH INSTITUTE, Daejeon (KR)

(72) Inventors: Soohwan LEE, Daejeon (KR); Myung Ki SHIN, Seoul (KR)

(73) Assignee: ELECTRONICS AND TELECOMMUNICATIONS RESEARCH INSTITUTE, Daejeon (KR)

(21) Appl. No.: 17/703,556

(22) Filed: Mar. 24, 2022

(30) Foreign Application Priority Data
Mar. 24, 2021 (KR) 10-2021-0037868
Mar. 23, 2022 (KR) 10-2022-0036100

(51) Int. Cl. H04W 48/16; H04W 24/10; H04W 24/08; H04W 48/18

(52) U.S. Cl. CPC H04W 48/16; H04W 24/10; H04W 24/08; H04W 48/18

(57) ABSTRACT

Invoking the network exposure subscribe service operation carrying the event reporting information to the NEF, receiving an event exposure notification sent from the NEF based on the reporting type parameter included in the event reporting information, and collecting data based on the event exposure notification A method and device for collecting data through the following steps are provided.

### CROSS-REFERENCE TO RELATED APPLICATION

This application claims priority to and the benefit of Korean Patent Application No. 10-2021-0037868 filed in the Korean Intellectual Property Office on Mar. 24, 2021 and Korean Patent Application No. 10-2022-0036100 filed in the Korean Intellectual Property Office on Mar. 23, 2022, the entire contents of which are incorporated herein by reference.

### BACKGROUND OF THE INVENTION

(a) Field of the Invention

This disclosure relates to a method and apparatus for collecting data through subscription of an event exposure service.

(b) Description of the Related Art

In 3GPP 5G system, a network function such as a network data analysis function (NWDAF) can collect data related to user equipment (UE) and generate analytics for the UE. However, too much raw data has been collected from network functions and application functions of the mobile communication system, and the raw data too frequently occurs, so the load on the system generated by the data collection become large.

The above information disclosed in this Background section is only for enhancement of understanding of the background of the invention, and therefore it may contain information that does not form the prior art that is already known in this country to a person of ordinary skill in the art.

### SUMMARY OF THE INVENTION

Embodiments of the invention provide a method for collecting data from an AF through an NEF.

Embodiments of the invention provide another method for collecting data from an AF through an NEF.

Embodiments of the invention provide a method for providing data to an NF through an NEF.

An embodiment of the invention provides a method for collecting data from an application function (AF) through a network exposure function (NEF). In such an embodiment, the method includes: invoking network exposure subscribe service operation carrying event reporting information to the NEF; receiving, from the NEF, an event exposure notification transmitted based on a reporting type parameter included in the event reporting information; and collecting the data based on the event exposure notification.

In such an embodiment, the method may further include performing analysis using the collected data.

In an embodiment, the collecting the data based on the event exposure notification may include determining that an event has disappeared when the event that is the same as an event included in a previous notification is included in the event exposure notification.

In an embodiment, the collecting the data based on the event exposure notification may include determining that an event has newly appeared when the event different from an event included in a previous notification is included in the event exposure notification.

In an embodiment, the collecting the data based on the event exposure notification may include determining that a second event corresponds to a change of a first event when the second event different from the first event included in a previous notification is included in the event exposure notification.

In an embodiment, the event exposure notification may be transmitted based on the reporting type parameter and a granularity of dynamics parameter included in the event reporting information.

In an embodiment, the collecting the data based on the event exposure notification may include inferring an event that occurred in the AF from the granularity of dynamics parameter and at least one event in a previous notification.

An embodiment of the invention provides a method for collecting data from an application function (AF) through a network exposure function (NEF). In such an embodiment, the method includes: invoking network exposure subscribe service operation carrying event reporting information to the NEF; receiving, from the NEF, an event exposure notification transmitted based on a granularity of dynamics parameter included in the event reporting information; and collecting the data based on the event exposure notification.

In an embodiment, the collecting the data based on the event exposure notification may include inferring an event that occurred in the AF from the granularity of dynamics parameter and at least one event in a previous notification.

In such an embodiment, the method may further include performing analysis using the collected data.

In an embodiment, the event exposure notification may be transmitted based on a reporting type parameter and the granularity of dynamics parameter included in the event reporting information.

In an embodiment, the collecting the data based on the event exposure notification may include determining that an event has disappeared when the event that is the same as an event included in a previous notification is included in the event exposure notification.

In an embodiment, the collecting the data based on the event exposure notification may include determining that an event has newly appeared when the event different from an event included in a previous notification is included in the event exposure notification.

In an embodiment, the collecting the data based on the event exposure notification may include determining that a second event corresponds to a change of a first event when the second event different from the first event included in a previous notification is included in the event exposure notification.

An embodiment of the invention provides a method for providing data to a network function (NF) through a network exposure function (NEF). In such an embodiment, the method includes: receiving, from the NEF, an invoking of network exposure subscribe service operation carrying event reporting information; and transmitting an event exposure notification to the NEF based on a reporting type parameter included in the event reporting information.

In an embodiment, the transmitting an event exposure notification to the NEF based on a reporting type parameter included in the event reporting information may include transmitting generated event to the NEF when the generated event is different from an event included in a previous event exposure notification

In an embodiment, the transmitting an event exposure notification to the NEF based on a reporting type parameter included in the event reporting information may include transmitting the event exposure notification to the NEF based on the reporting type parameter and granularity of dynamics parameter included in the event reporting information.

In an embodiment, the event exposure notification may include at least one of a range of scalar values, a list of event identification information, and a previous notification.

### BRIEF DESCRIPTION OF THE DRAWINGS

FIG. 1 is a schematic diagram illustrating the topology of a mobile communication system according to an embodiment.

FIG. 2 is a flowchart illustrating a method of subscribing/unsubscribing to an event exposure service according to an embodiment.

FIG. 3 is a flowchart illustrating a method for collecting data according to an embodiment.

FIG. 4 is a block diagram illustrating an NF device according to an embodiment.

### DETAILED DESCRIPTION OF THE EMBODIMENTS

In the following detailed description, only certain embodiments of the present invention have been shown and described in detail with reference to the accompanying drawing, simply by way of illustration. However, the present disclosure may be implemented in various different forms and is not limited to the embodiments described herein. Further, in order to clearly describe the description in the drawing, parts not related to the description are omitted, and similar reference numerals are attached to similar parts throughout the specification.

Throughout the specification, a user equipment (UE) may be called a terminal, mobile station (MS), a mobile terminal (MT), an advanced mobile station (AMS), a high reliability mobile station (HR-MS), a subscriber station (SS), a portable subscriber station (PSS), an access terminal (AT), a machine type communication device (MTC device), and the like and may also include all or some of the functions of the MS, the MT, the AMS, the HR-MS, the SS, the PSS, the AT, the UE, the MTCH device, and the like.

Further, the base station (BS) may be called an advanced base station (ABS), a high reliability base station (HR-BS), a node B, an evolved node B (eNodeB), an access point (AP), a radio access station (RAS), a base transceiver station (BTS), a mobile multi-hop relay (MMR)-BS, a relay station (RS) serving as a base station, a relay node (RN) serving as a base station, an advanced relay station (RS) serving as a base station, a high reliability relay station (HR-RS) serving as a base station, small base stations (a femto base station (femto BS), a home node B (HNB), a home eNodeB (HeNB), a pico base station (pico BS), a macro base station (macro BS), a micro base station (micro BS), and the like), and the like and may also include all or some of the functions of the ABS, the node B, the eNodeB, the AP, the RAS, the BTS, the MMR-BS, the RS, the RN, the ARS, the HR-RS, the small base stations, and the like.

In this specification, unless explicitly described to the contrary, the word “comprises”, and variations such as “including” or “containing”, will be understood to imply the inclusion of stated elements but not the exclusion of any other elements.

In this specification, expressions described in singular can be interpreted as singular or plural unless explicit expressions such as “one” or “single” are used.

In this specification, “and/or” includes all combinations of each and at least one of the mentioned elements.

In this specification, terms including ordinal numbers such as first and second may be used to describe various configurations elements, but the elements are not limited by the terms. The terms may be only used to distinguish one element from another element. For example, a first element may be named a second element without departing from the right range of the present disclosure, and similarly, a second element may be named a first element.

In the flowchart described with reference to the drawings in this specification, the order of the operations may be changed, several operations may be merged, certain operations may be divided, and specific operations may not be performed.

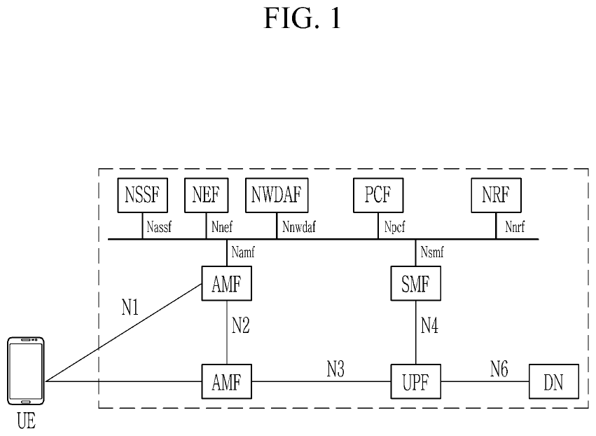

FIG. 1 is a schematic diagram illustrating the topology of a mobile communication system according to an embodiment.

Referring to FIG. 1, the core network of the wireless communication system according to an embodiment includes a plurality of network functions (NFs), and may connect the data network (DN) and a user equipment (UE).

An (radio) access network ((R)AN) may represent a base station providing 3GPP access and another base station or AP (access point) providing non-3GPP access such as Wi-Fi. The (R)AN may be connected to an access and mobility function (AMF) through an N2 interface and may be connected to a user plane function (UPF) through an N3 interface.

The AMF may be responsible for the mobility management function of the UE. The AMF may provide an access and mobility management function independently to the access technology, that is, to a unit of UE. Therefore, each UE may basically be connected to one AMF.

A session management function (SMF) may perform a function for managing a session up to the UE. When multiple sessions are maintained for one UE, different SMFs may be assigned for each session.

A policy control function (PCF) may determine policies such as session management and mobility management based on packet flow information received from the application function (AF) to ensure QoS (Quality of Service). The policy determined by the PCF may be transmitted to the AMF, the SMF, and the like, and then, functions such as the mobility management, the session management, the QoS management may be performed in each NF.

A DN may transfer a protocol data unit (PDU) to be transmitted to the UE to the UPF or may receive a PDU transmitted from the UE through the UPF. The UPF and the DN may be connected through an N6 interface.

The UPF may be configured using control signal information generated by SMF and UPF may report its status to the SMF through an N4 interface.

The UE and the AMF may be connected through an N1 interface.

An authentication server function (AUSF) may store data for authentication of the UE.

By collecting and analyzing various network data, the NWDAF may help optimization of operations of the network functions in the core network, such as the AMF, the SMF, and the PCF. The NWDAF may provide various analysis information and/or analytics required for optimizing the operations of the network functions by analyzing data, events, and state information from various network functions in the core network. Therefore, each network function can optimize its operation by utilizing various analysis information and/or analytics provided by the NWDAF.

A network repository function (NRF) is an entity in the core networks that may store information such as a profile of a network function (capacity, load, and state of the network function) and service (capacity of each service, load of each service, state of each service) of network function. The information stored in the NRF may be provided by invoking service operations such as NFDiscovery_Request and NFManagement_NFStatusNotify.

A network exposure function (NEF) is an entity that may safely expose services and capabilities provided by the 3GPP network functions to a third-party server outside the 3GPP network.

Any NF may discover and select a target NF to interact with through the NRF and the NEF.

Network capability exposures by the NEF in this description may include the following.
Exposure of network events externally as well as internally towards the core network NFs
Exposure of provisioning capabilities towards external functions
Exposure of policy and charging capabilities towards external functions
Exposure of core network internal capabilities for analytics
Exposure of analytics to an external party;
Retrieval of data from the external party by the NFs. In an embodiment, supporting the NF (e.g., NWDAF) of the core network to retrieve events of the external party and transferring the subscription/unsubscribe request for the event reporting service of the external party.

A consumer of the NF service (NF consumer) may provide the following to subscribe to the event reporting service.
at least one event ID(s): In an embodiment, the event ID is for identifying a type of the event to be subscribed to. According to an embodiment, the NF consumer may provide at least one service experience information of the event that can be subscribed, UE mobility information, UE communication information, and exception information.

The service experience information is analytics that may include an average of observed service MoS and/or a variance of observed service MoS indicating service MoS distribution for services such as audio-visual streaming as well as non-audio-visual streaming services such as V2X and web browsing service.

The exception information may include exception IDs indicating unexpected long-live/large rate flows and suspicion of DDoS attacks, exception levels, exception trends, and the like.
Event filter information: The event filter information may provide an event parameter type and an event parameter value to be matched against, in order to meet a condition for notifying the subscribed event ID. For example, the event parameter type may be an ‘area of interest’ and the event parameter value may be a list of tracking areas (TA). Alternatively, the event filter information may be information on a network slice of interest. The event filter information may depend on the event ID. That is, event filter information may be provided for each event ID to be subscribed to. Within the subscription, different event IDs may be associated with different event filter information.
Event reporting information: The event reporting information is described in Table 1 below. Within the subscription, all event IDs may be associated with unique event reporting information.
Target of event reporting: The target of event reporting may indicate a specific UE or PDU session, a group of UEs, or any UE (or all UEs). Within the subscription, all event IDs may be associated with the same target of the event reporting. In an embodiment, the target of the event reporting may correspond to a plurality of UEs or a plurality of PDU sessions.
Notification target address (+Notification Correlation ID): A notification target address may allow the NF receiving the event to correlate notifications received from an event provider with this subscription. The subscription may be associated with a unique notification target address (+the notification correlation ID). When an NF consumer subscribes to a service to an NF provider on behalf of another NF, the NF consumer may provide a notification target address (+the notification correlation ID) of the other NF for an event ID to be notified to the other NF directly. The notification target address (+the notification correlation ID) of NF consumer for subscription change may be related to an event notification. Each notification target address (+the notification correlation ID) may be associated with related event ID and/or set of event IDs.
Expiry time: The expiry time may indicate a time up to which the subscription is desired to be kept as active. The consumer of the NF service may suggest the expiry time and provide the expiry time to the producer of the NF service. Based on the operator's policy, the producer of the NF service may decide whether the subscription has expired. When the subscription may expire, the producer of the NF service may determine the expiry time and provide the determined expiry time in a response to the consumer of the NF service. When the event subscription is about to expire based on the received expiry time proposed by the consumer of the NF service and the consumer of the NF service wants to keep receiving notifications, the consumer of the NF service may update the subscription with the NF service producer in order to extend the expiry time. When the expiry time associated with the subscription is reached, the subscription may become invalid at the NF service producer. If the consumer of the NF service wants to keep receiving notifications, the consumer of the NF service needs to create a new subscription with the producer of the NF service.

When the subscription is accepted by the event provider NF, the consumer of the NF service may receive, from the event provider NF, an identifier (subscription correlation ID) allowing to further manage (modification, deletion, etc.) the subscription.

In an embodiment, the notification correlation ID may be allocated by a consumer NF that subscribes to the event reporting, and the subscription correlation ID may be allocated by the NF that notifies when the event is met. Since both correlation identifiers may be assigned as the same value, although in principle they are supposed to be different, since they are optimized to find the subscription related context within each NF.

The consumer NF may use an operation dedicated to subscription modification to add or remove event ID(s) to the subscription or to modify the event filter information.

Events may be subscribed to by consumer NFs by providing the event filters. In addition, explicit unsubscription by the NF consumer is still possible. The contents of the event reporting information along with the presence requirement of each information element are described in Table 1.

TABLE 1
Table 4.15.1-1: Event Reporting Information

[symbol]

| Event Reporting Information | | Presence |
|---|---|---|
| Parameter [symbol] | Description [symbol] | requirement [symbol] |
| Event reporting mode [symbol] | Mode of reporting - e.g. reporting up to a maximum | mandatory [symbol] |
| | number of reports, periodic reporting along with | |
| | periodicity. reporting up to a maximum duration [symbol] | |
| Maximum number of reports [symbol] | Maximum number of reports after which the event | (see NOTE 2) [symbol] |
| | subscription ceases to exist [symbol] | |
| Maximum duration of reporting [symbol] | Maximum duration after which the event subscription | (see NOTE 2) [symbol] |
| | ceases to exist [symbol] | |
| Immediate reporting flag [symbol] | The Event provider NF notifies the current status of the | [symbol] |
| | subscribed event, if available, immediately to the | |
| | consumer NF [symbol] | |
| Sampling ratio [symbol] | Percentage of sampling (1% . . . 100%) among impacted | optional [symbol] |
| | UEs. [symbol] | (see NOTE 3) [symbol] |
| Group Reporting Guard Time [symbol] | Parameter for group-based monitoring configuration to | optional [symbol] |
| | indicate the time for which the Monitoring Event | |
| | Reporting(s) related with the UEs in a group can be | |
| | aggregated before sending them to the consumer NF. [symbol] | |
| Granularity of dynamics [symbol] | The maximum amount of dynamics in the event which | optional [symbol] |
| | allows to skip an event notification. [symbol] | (see NOTE 4) [symbol] |
| Reporting type [symbol] | Event provider NF reports only when the events differs | optional [symbol] |
| | from the previously notified event. [symbol] | (see NOTE 5) [symbol] |

NOTE 2:
The requester shall include 2) Maximum number of reports or 3) Maximum duration of reporting, or both, depending on 1) Event reporting mode [symbol]
NOTE 3:
Parameter only applicable to certain event IDs reporting metrics (e.g. Number of UEs present in a geographical area) used and used e.g. by the NWDAF for data collection [symbol]
NOTE 4:
The Granularity of dynamics includes 1) the range of scalar value, 2) the list of events identification, or 3) the previous notification. The range of scalar value is only applicable to the event depicted as number, (e.g., the number of UE), the others is applicable to the event depicted as identification (e.g., UE location, UE identification). [symbol]
NOTE 5:
The differences in event includes the events have been newly appeared, disappeared, and changed from the previous notification.

[symbol]

In Table 1, the maximum number of reports may be applicable to the subscription for one UE or a group of UEs. When a subscription is applied to a group of UEs, the parameters may be applied to each individual member UEs in the group, respectively. The numbers of the reports may be counted per the granularity of dynamics.

Maximum duration of reporting may be applicable to the subscriptions for one UE, a group of UEs, or any UE. When a subscription is applied to a group of UEs, the maximum duration of reporting parameter may be applied to each group member UE. When the subscription is applied to any UE, the maximum duration of reporting parameter may be applied to all the impacted UEs.

For a given subscription, if both the Maximum number of reports parameter and Maximum Duration of reports parameter are included, the subscription may be considered to expire when one of the conditions according to the two parameters is met (e.g., as soon as one of the conditions is met).

A sampling ratio may be applicable to a subscription targeting a group of UEs or any UE. When the sampling ratio is provided, a random subset among the target UEs may be selected according to the sampling ratio, and events related to the selected subset may be only reported. The UE may remain selected until it is not managed by the event provider NF. A UE newly managed by the NF may be selected.

A group reporting guard time is an optional parameter for group-based monitoring configuration for indicating the time for which monitoring event reporting(s) related to a UE in a group can be aggregated before being sent to the consumer NF. A value of the group reporting guard time needs to be set smaller than maximum duration of reporting. For continuous monitoring of the reporting, unless the maximum duration of reporting has been reached, the group reporting guard time may be restarted after expiration. If the remaining time until the maximum duration of reporting is less than the group reporting guard time, the group reporting guard timer needs to be set to expire when the maximum duration of reporting expires. If the maximum duration of reporting expires, the group reporting guard time, even if running, may be considered expired and aggregated monitoring event reporting(s) may be sent to a destination immediately.

Granularity of dynamics may indicate negligible changes in a target event of the subscription for which notifications is not required. The changes in the granularity of dynamics may be indicated as a range of scalar values (x,y), a list of event identification(s) (e.g., a list of SUPI(s)), or a previous notification. (x,y) for the range of scalar value may mean [the previously notified scalar value−x, the previously notified scalar value+y). If the granularity of dynamics is provided, the provider NF may send a notification only when the changes in the target event are not described in the granularity of dynamics. Even if the granularity of dynamics is provided, the provider NF may send the first notification as it is.

The reporting type is a parameter to reduce data volume of a notification. If the reporting type is provided, the provider NF may notify an event that have been newly appeared, disappeared, or changed compared to the previous notification. Even if the reporting type is provided, the provider NF may send the first notification as it is.

A notification corresponding to a subscription may include at least a notification correlation ID together with an event ID and an individual target (e.g., UE or PDU session ID) associated with the notification.

When the consumer of the NF service decides to terminate the event subscription, the consumer of the NF service may unsubscribe the event subscription by sending an unsubscription request to the event provider NF. After receiving the unsubscription request for unsubscribing the event subscription from the consumer of the NF service, the event provider NF may terminate the event subscription.

Below, the external exposure of the network capabilities and the internal exposure of the event and capabilities of the core network will be described.

When the immediate reporting flag of Table 1 is set, if the corresponding information is available at the reception of the subscription request of the event, the first corresponding event report may be included in the output.

The optional parameter MTC provider information may be a reference parameter that may be provided by the AF or a reference parameter that may be determined by the NEF based on the AF to communicate with. The MTC provider information may identify the MTC service provider and/or MTC application. The MTC provider information may be used by a service provider, for example, to distinguish their different customers.

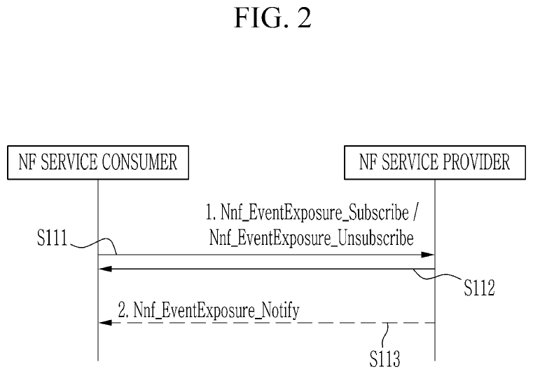

FIG. 2 is a flowchart illustrating a method of subscribing/unsubscribing to an event exposure service according to an embodiment.

According to an embodiment, the consumer of the NF service may subscribe/unsubscribe to an event exposure service for collecting data on a related event. In an embodiment, the consumer of the NF service may be an entity in a cellular system such as the NWDAF.

The NF service consumer according to an embodiment may use a network exposure service provided by each network functions (NFs) to increase the efficiency of the data collection and enable real-time (or near real-time) collection of the data. The procedure shown in FIG. 2 may be used when a consumer of NF service (such as the NWDAF) subscribes/unsubscribes to data or event of trusted AF of an external network.

When the NF service consumer sends a subscription request to the NF service provider through service operation for a subscription of the network exposure service, parameters about negligible errors indicated by granularity of dynamics in Event reporting information regarding required data in a notification of each NF may be transferred together to the NF service provider. In addition, the subscription request may include parameters for requesting only the data not transferred in the previous notification as required data.

Referring to FIG. 2, the NF service consumer according to an embodiment may request a subscription for an event ID to the NF service provider by invoking Nnf_EventExposure_Subscribe service operation. Alternatively, the NF service consumer may request the NF service provider to unsubscribe from the event ID by invoking Nnf_EventExposure_Unsubscribe service operation (S111).

The service operation for the subscription of the event exposure service may carry the granularity of dynamics parameter and the reporting type parameter. The granularity of dynamics parameter and the reporting type parameter may be predetermined by the NF service consumer.

Required data may be indicated by an event ID, an event filter (e.g., area information) and type of the event reporting (e.g., all UEs, UEs within a specific group, or specific UEs) carried in the service operation for requesting the event exposure subscription.

The NF service provider may be one of several network functions in the mobile communication system. Then, the NF service provider may transmit an output according to the service operation of the event exposure subscription to the NF service consumer and subscription/unsubscription for the event ID may be completed according to this output (S112).

The NF service consumer according to an embodiment may determine a negligible change for required data and may set the granularity of dynamics based on the determined negligible change. The negligible change determined by the NF service consumer may be a range of data that the NF reporting the requested data can ignore based on the granularity of dynamics. In addition, the NF service consumer according to an embodiment may determine the reporting type to reduce the number of events to be collected and signaling overhead of the core network and each network function.

Specifically, the NF service consumer according to an embodiment may determine the granularity of dynamics and the reporting type as the event reporting information for the operation of the event exposure subscription.

When the granularity of dynamics parameter is set by the consumer NF (e.g., the NWDAF) in the event exposure subscription procedure, the event exposure subscription request (Nnf_EventExposure_Subscribe) service operation carrying the granularity of dynamics parameter is invoked by the consumer NF. Then, the producer NF may transmit a notification including the requested data to the consumer NF.

The producer NF may transmit the notification including the requested data to the consumer NF at a periodic or aperiodic reporting cycle during the subscription of event exposure.

When a change in the requested data from the first notification to the second notification for the consumer NF is included within the data range determined by the granularity of dynamics, the producer NF may not transmit the requested data as the second notification. The producer NF may determine whether the change in requested data during one reporting cycle is included within the range determined by the granularity of dynamics. For example, when the change in the requested data is less than the range predetermined by the granularity of dynamics or the requested data is included in the data set of the previous notification (e.g., requested data ⊂ data set of the previous notification), the producer NF may not transmit the requested data to consumer NF despite event exposure subscription.

If the consumer NF does not receive a notification including the required data during the reporting cycle, the consumer NF may infer data for the current reporting cycle from the data in the notification received in the previous reporting cycle based on the granularity of dynamics. For example, NWDAF may infer data corresponding to the current reporting cycle by adding Gaussian noise (e.g., Gaussian noise with an average of 0 (zero-mean Gaussian noise)) to the data included in the previous notification. Through this, NWDAF may acquire an entire record of required data corresponding to all reporting cycle during the subscription period and the frequency of the notification (or provisioning) of the required data can be greatly reduced.

The reporting type parameter may be set to use a data set which differs from the previous notification or may be set to use all of the required data.

When the reporting type parameter is set to use a data set different from the previous notification, the producer NF may transmit, to the consumer NF through a notification, a data set including newly added data, or deleted data, or changed data compared to the previous notification.

When the reporting type parameter is set to use all required data, the producer NF may transmit a notification containing the entire set of required data to the consumer NF in each reporting cycle of the event notification.

When the NF service consumer sets the reporting type parameter to use a data set representing the difference from the previous notification, the NF service consumer may receive, from the producer NF, a notification including newly added data, or deleted data, or changed data. In an embodiment, the NF service consumer may re-assemble the data in the previous notification and data in a notification subsequent to the previous notification or may infer data corresponding to the current notification from the data in the previous notification. Therefore, the reporting type parameter can make it possible to reduce data volume in each notification without loss of the required data.

The granularity of dynamics parameter and reporting type parameter transmitted to the NF service provider by the event exposure subscription request service operation may be maintained during the event exposure subscription of the NF service consumer. The duration of the event exposure subscription may include a plurality of periodic or aperiodic reporting cycles in which the notifications are transmitted to the NF service consumer. The granularity of dynamics parameter and the reporting type parameter may be updated by re-invoking the Nnf_EventExposure_Subscribe service operation.

The NF service provider according to an embodiment may transmit the requested data to the NF service consumer through a first notification after the event exposure subscription initiates. Thereafter, the NF service provider may transmit the requested data to the NF service consumer through an event exposure notification (Nnf_EventExposure_Notify) based on the granularity of dynamics and the reporting type (S113). For example, when the change in requested data between the previous reporting cycle and the next reporting cycle is within the range determined by the granularity of dynamics, the NF service provider may not transmit the event exposure notification to the NF service consumer in the next reporting cycle. Alternatively, when the change in the requested data is larger than the range determined by the granularity of dynamics, the NF service provider may transmit the event exposure notification to the NF service consumer in the next reporting cycle.

When the NF service provider according to an embodiment transmits the event exposure notification to the NF service consumer in a reporting cycle, the NF service provider may transmit all requested data or may transmit a data set different from the requested data of the previous notification according to the reporting type parameter. For example, when the reporting type parameter instructs to report a difference from the previous notification, the NF service provider may transmit, to the NF service consumers, an event exposure notification including a data set including newly added data, or deleted data, or changed data.

In an embodiment, the first notification (e.g., first event exposure notification) transmitted by the NF service provider to the NF service consumer may include all requested data regardless of the reporting type.

Referring to FIG. 2, when the NF service consumer does not receive an event exposure notification from the NF service provider in the next reporting cycle subsequent to the reporting cycle in which the data set has been received, the NF service consumer may infer data corresponding to the next reporting cycle from the data set in the previous notification based on the granularity of dynamics. That is, the NF service consumer may infer data corresponding to the next reporting cycle subsequent to the previous reporting cycle from the data set received in the previous reporting cycle based on the granularity of dynamics even if there is no notification or data set being received in the current reporting cycle.

When the NF service consumer receives an event exposure notification from the NF service provider at the end of the reporting cycle and the event exposure notification includes a data set representing the difference from the previous notification, the NF service consumer may re-assemble the required data and the data set in the previous notification. Afterwards, the NF service consumer may perform analysis using the inferred data set, the re-assembled data set, and/or all required data sets.

If the event ID of the event exposure subscription supports the collection of multiple data from the NF (i.e., when the collection of a plurality of type of data is indicated by the event ID), the NF service consumer may set the granularity of dynamics for each data. Different types of granularity of dynamics may be applied to different types of data that is to be collected. Table 2 below shows examples of each type of data and examples of the granularity of dynamics that can be applied to each type of data.

TABLE 2

| | | Examples of |
|---|---|---|
| Data type | Example of data | the granularity of dynamics |
| Data represented by | application ID, filter information, | i) Previous notification |
| identifiers | location of an application (e.g., | or |
| (identification) | list of DNAI), UE ID(s) (e.g., | ii) List of identifiers (e.g., list of |
| | SUPI, GPSI), UE group ID, | TA(s), etc.) |
| | DNN, S-NSSAI, QFI, TAC, UE | |
| | location, Exception ID, | |
| | Exception trend | |
| Data represented by | service experience, QoS flow bit | iii) range of scalar values: |
| numbers | rate, QoS flow packet delay, | a range of scalar values x and y |
| | packet transmission, packet | to data requested in a previous |
| | retransmission, traffic use report, | notification (e.g., [the previously |
| | number of UEs, frequent mobility | notified scalar value - x, the |
| | registration update, UL data | previously notified scalar value + |
| | rate, DL data rate, traffic volume, | y)) |
| | exception level | |

In Table 2, i) when the previous notification is applied as the granularity of dynamics, the producer NF may transmit a notification only when the requested data is different from the data of the previous notification. For example, when the NWDAF collects the UE ID through subscription of the Nnf_EventExposure service according to the granularity of dynamics, the producer NF may compare collected data with the data in the previous notification and may invoke the Nnf_EventExposure_Notify service operation when a new UE ID is added to the data in the previous notification or an existing UE ID has disappears from the data in the previous notification.

ii) When a list of event identification information (List of events identification) is included in the granularity of dynamics parameter, the producer NF may invoke the Nnf_EventExposure_Notify service operation when the change of the requested data (e.g., identifier or ID) is not included in the ‘list of event identification information’. For example, when the NWDAF collects the UE location through subscription of the Nnf_EventExposure service and the granularity of dynamics is set to a predetermined TA list, the producer NF may invoke the Nnf_EventExposure_Notify service operation when the UE location is changed to a TA that does not belong to the TA list of the granularity of dynamics.

iii) When the range of scalar value is included in the granularity of dynamics parameter, the producer NF may invoke the Nnf_EventExposure_Notify service operation when the requested data is out of the range ([the previously notified scalar value−x, the previously notified scalar value+y)). For example, when NWDAF collects the number of UEs within a specific area from the AMF and the granularity of dynamics is set to x=10, and y=11, the AMF may not invoke the Nnf_EventExposure_Notify service operation when number of UEs within the specific area is [−10, 11) for the data in the previous notification. Thereafter, the NWDAF may determine, through inference, the data corresponding to the event reporting cycle within the range of [previous data−10, previous data+11).

When the ‘reporting type’ is set to use a data set that differs from the previous notification, the producer NF may compare collected data with the previous notification and may report, to the consumer NF at the event notification cycle, a data set including newly added data, or deleted data, or changed data.

The granularity of dynamics parameter and the reporting type parameter carried in the Nnf_EventExposure_Subscribe service operation may be applied to one event specific parameter. A data set including a plurality of event specific parameters (i.e., a data set configured by a plurality of event specific parameters) may be transmitted to the NF service consumer through the Nnf_EventExpsoure_Notify service operation.

When the granularity of dynamics is set, an invoking condition of the Nnf_EventExpsoure_Notify may be as follows.
Event ID supports single data collection: The producer NF may invoke the Nnf_EventExposure_Notify when data change is out of range of scalar value determined from the granularity of dynamics.
Event ID supports multiple data collection (e.g., service data collected from AF):
   When the granularity of dynamics is set only for specific data, the producer NF may invoke the Nnf_EventExposure_Notify service operation when a change of specific data is out of the range of the granularity of dynamics.
   When the granularity of dynamics is set for different types of data, the producer NF may invoke the Nnf_EventExposure_Notify when at least one change to data is out of the range of the granularity of dynamics.

For example, when the NWDAF collects a data set of SUPI, the UE location for a specific UE group from the AMF (Event ID=Location Report), and the granularity of dynamics is set as “previous notification” for the SUPI and the UE location, respectively, the producer NF may invoke the Nnf_EventExposure_Notify when at least one UE location is changed from the UE location of the previous notification or the target SUPI is changed due to UE mobility (e.g., a new UE moves into an area or an existing UE moves out of the area).

When the ‘reporting type’ is set in the Nnf_EventExposure_Subscribe procedure, the event specific parameter which may be transmitted to the NF service consumer by the Nnf_EventExposure_Notify may include the following content.
When the ‘reporting type’ is set to use a data set representing differences from previous notifications,
   If the granularity of dynamics is not applied to the subscription, the event-specific parameters may include i) newly added data, ii) deleted data, and iii) changed data compared to previous notifications. If the same data is included in the notification compared to the previous notification, the NWDAF may recognize that the data is ii) deleted from the previous notification. If data that is not identical compared to the previous notification is included in the current notification, the NWDAF may recognize the data in the notification as i) newly added data or iii) changed data.
   When the granularity of dynamics is applied to a subscription, the event specific parameters may include data of which change is not described within the granularity of dynamics. If the notification includes the same data compared to the previous notification, the NWDAF may recognize that the data in the notification is ii) deleted from the previous notification. If the data that is not the same compared to the previous notification is included in the notification, the NWDAF may recognize the corresponding data in the notification as i) newly added data or iii) changed data.
When the ‘reporting type’ is set to use all required data, the event specific parameters may include all required data.

As described above, the NF service consumer can improve the Nnf_EventExposure_Subscribe service operation and Nnf_EventExposure_Notify service operation by using the granularity of dynamics parameter and the reporting type parameter.

The NF service consumer according to an embodiment can determine the appropriate granularity of dynamics for the data required to generate an analytics and can infer the required data during the subscription period from the difference conditionally reported on the previous notification. In addition, for all NF service providers in the mobile communication system that exposes the events, when there is a change of data outside the predetermined range of the granularity of dynamics (e.g., data change that is not described by the granularity of dynamics) during the event reporting cycle, the network data requested in a view of the difference from the previous notification may be provided to the NF service consumer.

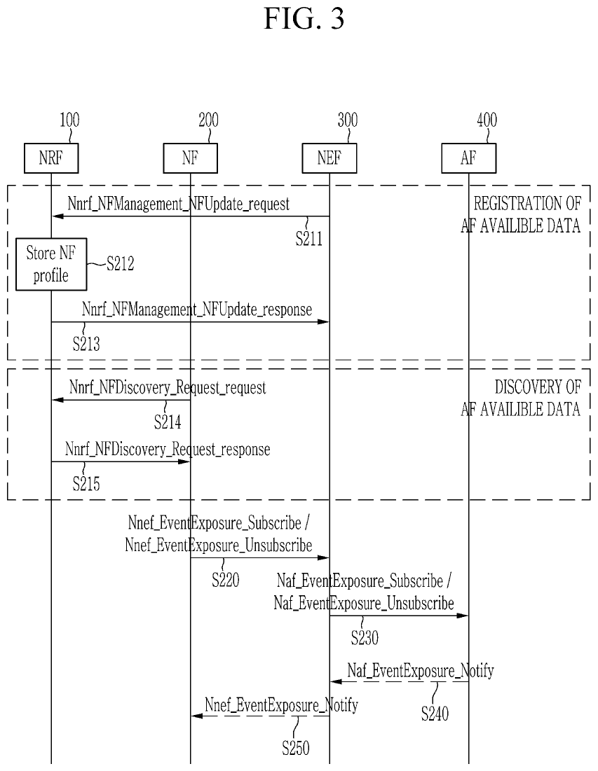

FIG. 3 is a flowchart illustrating a method for collecting data according to an embodiment.

A consumer of an NF service (e.g., NWDAF) according to an embodiment may collect data and/or information from AF through a provider (e.g., NEF) of an NF service (e.g., event exposure service). Available data that an AF can provide to consumers of an NF service (e.g., AF collectable data or AF available data) may be registered in the NEF, and if necessary, the AF available data may be registered in the NEF through OAM configuration. The AF available data may include at least one of AF identity information (AF identification), AF service identification information (AF service identification), and available data to be collected per application. For example, the AF service identification information may be endpoint information of a Naf_EventExposure service operation. The available data to be collected for each application may be identified by, for example, event ID(s).

Referring to FIG. 3, After the AF available data is registered in the NEF 300, the NEF 300 may create an event exposure service related to the AF available data. In an embodiment, the event exposure service related to the AF available data may have a new event ID (EventID). Thereafter, the NEF 300 may update registration information (e.g., NF profiles of the NEF) of the NEF 300 to the NRF 100 by invoking Nnrf_NFManagement_NFUpdate_request service operation (S211). In an embodiment, the registration information of the NEF 300 may include at least one of an event ID newly generated for the AF available data, AF identification information related to the generated event ID, and application ID(s).

Upon receiving the update request of the registration information from the NEF 300, the NRF 100 may store the registration information (i.e., the NF profiles of the NEF 300) of the NEF 300 (S212). In an embodiment, the registration information of the NEF 300 to be stored in the NRF 100 may include information on AF available data (e.g., event ID connected to the AF available data, AF identification information related to the event ID, and application ID, etc.). Thereafter, the NRF 100 may invoke Nnrf_NFManagement_NFUpdate_response service operation for the NEF 300 (S213).

Thereafter, when the NF service consumer 200 needs to collect available data from the AF 400, the NF service consumer 200 may invoke Nnrf_NFDiscovery_Request_request service operation for the NRF 100 (S214). In an embodiment, the NF service consumer 200 may query, to the NRF 100, an appropriate NEF 300 to collect available data using NEF NF type, a list of event IDs, etc. as parameters. As parameters to be transmitted by the NF service consumer 200 to the NRF 100, the AF identification information and application ID may also be used.

The NRF 100 may match the query of the NF service consumer 200 regarding the AF available data with the registered NF profile of the NEF 300, and invoke the Nnrf_NFDiscovery_Request_response service operation to deliver information about the matched NEF 300 to the NF service consumer 200 (S215). Thereafter, the NF service consumer 200 may identify the AF available data for each application, and may determine an appropriate NEF 300 to collect the identified AF available data.

The NF service consumer 200 may subscribe to the event exposure service for collecting data from the AF 400 by invoking Nnef_EventExposure_Subscribe service operation to the NEF 300. Alternatively, the NF service consumer 200 may unsubscribe to the event exposure service for collecting the data from the AF 400 by invoking Nnef_EventExposure_Unsubscribe service operation to the NEF 300 (S220). When the subscription of the event exposure service is authorized by the NEF 300, the NEF 300 may record association between an event trigger and an identity of the NF service consumer 200. User consent for the NF service consumer 200 to retrieve user data in the AF may or may not be necessary, and the user consent may be stored in the NEF 300.

In an embodiment, the Nnef_EventExposure_Subscribe service operation transmitted to the NEF 300 by the NF service consumer 200 may carry event reporting information. The event reporting information may include at least one of a reporting type and/or a granularity of dynamics.

The NEF 300 may subscribe to the event exposure service for collecting data from the AF 400 by invoking Naf_EventExposure_Subscribe service operation to the AF 400. Alternatively, the NEF 300 may unsubscribe the event exposure service by invoking Naf_EventExposure_Unsubscribe service operation to the AF 400 (S230). In an embodiment, the Naf_EventExposure_Subscribe/Unsubscribe may carry at least one of a reporting type parameter and a granularity of dynamics parameter.

When the NEF 300 subscribes to the event exposure service for collecting data from the AF 400, the AF 400 may notify the NEF 300 of events related to the AF available data by invoking Naf_EventExposure_Notify service operation according to the event reporting information of the subscription (S240).

Thereafter, when a notification related to the events is received from the AF 400, the NEF 300 may transmit the event related to the AF available data to the NF service consumer 200 by invoking the Nnef_EventExposure_Notify service operation (S250).

When the reporting type parameter is included in the event reporting information of step S220, the AF 400 may transmit the event related to AF available data to the NEF 300 through the notification if an occurred event is different from an event previously reported. Alternatively, the NEF 300 may transmit the event related to AF available data to the NF service consumer 200 if the event received from the AF 400 is different from an event previously reported. In an embodiment, the difference between the event received from the AF 400 and the previously reported event may include at least one of a newly appeared event, a disappeared event, and a changed event from a previously reported event or notification.

When an event that is the same as an event included in a previous notification is included in the notification from the NEF 300, the NF service consumer 200 may determine that the same event has disappeared. Otherwise, the NF service consumer 200 may determine that the event is newly appeared or changed. For example, when an event different from an event included in the previous notification is included in the event exposure notification, the NF service consumer 200 may determine that the different event has newly appeared or the different event has been changed. Also, the NF service consumer 200 may restore, from the previous notification, an event that is not included in a current notification but is included in the previous notification.

When the granularity of dynamics parameter is included in the event reporting information of step S220, the NF service consumer 200 may infer an event that occurred in the AF 400 from the applied granularity of dynamics and the event(s) in the previous notification.

As described above, as the consumer NF collects network data based on the granularity of dynamics and the reporting type from the AF through the NEF, the efficiency of data collection can be improved, and real-time data collection can be improved.

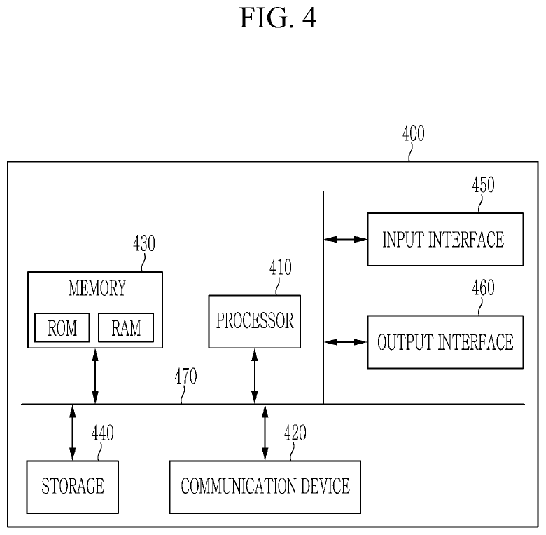

FIG. 4 is a block diagram illustrating an NF device according to an embodiment.

The NF device according to another embodiment may be one of NFs in a communication system and may be implemented as a computer system, for example, a computer-readable medium. Referring to FIG. 4, the computer system 400 may include at least one of a processor 410, a memory 430, an input interface device 450, an output interface device 460, and a storage device 440 communicating through a bus 470. The computer system 400 may also include a communication device 420 coupled to the network. The processor 410 may be a central processing unit (CPU) or a semiconductor device that executes instructions stored in the memory 430 or the storage device 440. The memory 430 and the storage device 440 may include various forms of volatile or nonvolatile storage media. For example, the memory may include read only memory (ROM) or random-access memory (RAM). In the embodiment of the present disclosure, the memory may be located inside or outside the processor, and the memory may be coupled to the processor through various means already known. The memory is a volatile or nonvolatile storage medium of various types, for example, the memory may include read-only memory (ROM) or random-access memory (RAM).

Accordingly, the embodiment may be implemented as a method implemented in the computer, or as a non-transitory computer-readable medium in which computer executable instructions are stored. In an embodiment, when executed by a processor, the computer-readable instruction may perform the method according to at least one aspect of the present disclosure.

The communication device 420 may transmit or receive a wired signal or a wireless signal.

On the contrary, the embodiments are not implemented only by the apparatuses and/or methods described so far, but may be implemented through a program realizing the function corresponding to the configuration of the embodiment of the present disclosure or a recording medium on which the program is recorded. Such an embodiment can be easily implemented by those skilled in the art from the description of the embodiments described above. Specifically, methods (e.g., network management methods, data transmission methods, transmission schedule generation methods, etc.) according to embodiments of the present disclosure may be implemented in the form of program instructions that may be executed through various computer means, and be recorded in the computer-readable medium. The computer-readable medium may include program instructions, data files, data structures, and the like, alone or in combination. The program instructions to be recorded on the computer-readable medium may be those specially designed or constructed for the embodiments of the present disclosure or may be known and available to those of ordinary skill in the computer software arts. The computer-readable recording medium may include a hardware device configured to store and execute program instructions. For example, the computer-readable recording medium can be any type of storage media such as magnetic media like hard disks, floppy disks, and magnetic tapes, optical media like CD-ROMs, DVDs, magneto-optical media like floptical disks, and ROM, RAM, flash memory, and the like.

Program instructions may include machine language code such as those produced by a compiler, as well as high-level language code that may be executed by a computer via an interpreter, or the like.

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software. The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers.

A computer program(s) may be written in any form of a programming language, including compiled or interpreted languages, and may be deployed in any form including a stand-alone program or a module, a component, a subroutine, or other units suitable for use in a computing environment.

A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random-access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks.

Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium.

A processor and a memory may be supplemented by, or integrated into, a special purpose logic circuit. The processor may run an operating system 08 and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements.

For example, a processor device may include multiple processors or a processor and a controller. In addition, different processing configurations are possible, such as parallel processors. Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment.

Features described in the specification in the context of individual example embodiments may be implemented as a combination in a single example embodiment. In contrast, various features described in the specification in the context of a single example embodiment may be implemented in multiple example embodiments individually or in an appropriate sub-combination.

Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

While this disclosure has been described in connection with what is presently considered to be practical example embodiments, it is to be understood that this disclosure is not limited to the disclosed embodiments.

On the contrary, it is intended to cover various modifications and equivalent arrangements included within the spirit and scope of the appended claims.

While this invention has been described in connection with what is presently considered to be practical embodiments, it is to be understood that the invention is not limited to the disclosed embodiments. On the contrary, it is intended to cover various modifications and equivalent arrangements included within the spirit and scope of the appended claims.

What is claimed is:

1. A method for collecting data from an application function (AF) through a network exposure function (NEF), the method comprising:
invoking network exposure subscribe service operation carrying event reporting information to the NEF;
receiving, from the NEF, an event exposure notification transmitted based on a reporting type parameter included in the event reporting information; and
collecting the data based on the event exposure notification.

2. The method of claim 1 further comprises
performing analysis using the collected data.

3. The method of claim 1, wherein
the collecting the data based on the event exposure notification comprises
determining that an event has disappeared when the event that is the same as an event included in a previous notification is included in the event exposure notification.

4. The method of claim 1, wherein
the collecting the data based on the event exposure notification comprises
determining that an event has newly appeared when the event different from an event included in a previous notification is included in the event exposure notification.

5. The method of claim 1, wherein
the collecting the data based on the event exposure notification comprises
determining that a second event corresponds to a change of a first event when the second event different from the first event included in a previous notification is included in the event exposure notification.

6. The method of claim 1, wherein
the event exposure notification is transmitted based on the reporting type parameter and a granularity of dynamics parameter included in the event reporting information.

7. The method of claim 6, wherein:
the collecting the data based on the event exposure notification comprises
inferring an event that occurred in the AF from the granularity of dynamics parameter and at least one event in a previous notification.

8. A method for collecting data from an application function (AF) through a network exposure function (NEF), the method comprising:
invoking network exposure subscribe service operation carrying event reporting information to the NEF;
receiving, from the NEF, an event exposure notification transmitted based on a granularity of dynamics parameter included in the event reporting information; and
collecting the data based on the event exposure notification.

9. The method of claim 8, wherein
the collecting the data based on the event exposure notification comprises
inferring an event that occurred in the AF from the granularity of dynamics parameter and at least one event in a previous notification.

10. The method of claim 8, wherein
performing analysis using the collected data.

11. The method of claim 8, wherein
the event exposure notification is transmitted based on a reporting type parameter and the granularity of dynamics parameter included in the event reporting information.

12. The method of claim 11, wherein:
the collecting the data based on the event exposure notification comprises
determining that an event has disappeared when the event that is the same as an event included in a previous notification is included in the event exposure notification.

13. The method of claim 11, wherein
the collecting the data based on the event exposure notification comprises
determining that an event has newly appeared when the event different from an event included in a previous notification is included in the event exposure notification.

14. The method of claim 11, wherein
the collecting the data based on the event exposure notification comprises
determining that a second event corresponds to a change of a first event when the second event different from the first event included in a previous notification is included in the event exposure notification.

15. A method for providing data to a network function (NF) through a network exposure function (NEF), the method comprising:
receiving, from the NEF, an invoking of network exposure subscribe service operation carrying event reporting information; and
transmitting an event exposure notification to the NEF based on a reporting type parameter included in the event reporting information.

16. The method of claim 15, wherein
the transmitting an event exposure notification to the NEF based on a reporting type parameter included in the event reporting information comprises
transmitting generated event to the NEF when the generated event is different from an event included in a previous event exposure notification

17. The method of claim 15, wherein
the transmitting an event exposure notification to the NEF based on a reporting type parameter included in the event reporting information comprises
transmitting the event exposure notification to the NEF based on the reporting type parameter and granularity of dynamics parameter included in the event reporting information.

18. The method of claim 17, wherein
the event exposure notification includes at least one of a range of scalar values, a list of event identification information, and a previous notification.
